(19) United States
(12) Patent Application Publication
(10) Pub. No.: US 2007/0163054 A1
(43) Pub. Date: Jul. 19, 2007

(54) Benefit compositions

(75) Inventors: Jiping Wang, West Chester, OH (US); Shannon Dale Wagers, Liberty Twp., OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/654,714

(22) Filed: Jan. 18, 2007

Related U.S. Application Data
(60) Provisional application No. 60/760,224, filed on Jan. 19, 2006.

(51) Int. Cl. C11D 3/00

(52) U.S. Cl. 8/115.51

(57) ABSTRACT

This invention relates to textile benefit compositions that can maintain or rejuvenate article's stain repellency and processes for making and using such compositions. Such article may be a textile product.

### CROSS-REFERENCES TO RELATED APPLICATIONS

This application claims priority under 35 U.S.C. §119(e) to U.S. Provisional Application Ser. No. 60/760,224 filed Jan. 19, 2006.

### FIELD OF INVENTION

This invention relates to benefit compositions that can maintain or rejuvenate an article's stain repellency and processes for making and using such compositions.

### BACKGROUND OF THE INVENTION

Due to use and cleaning, articles, for example, articles that comprise fibers such as garments and linens are generally treated with compositions that provide such articles with a degree of stain repellency. Unfortunately the effectiveness of such treatment compositions is fleeting and/or limited. Will not being bound by theory, Applicants believe that such loss in effectiveness is do to the adherence of materials that attract stains to the article's stain repellant coating.

Accordingly, there is a need for textile benefit compositions that can maintain or rejuvenate a textile product's stain repellency and processes for making and using such compositions.

### SUMMARY OF THE INVENTION

This invention relates to textile benefit compositions that can maintain or rejuvenate article's stain repellency and processes for making and using such compositions. Such article may be a textile product.

### DETAILED DESCRIPTION OF THE INVENTION

### Definitions

As used herein, the term “textile products” includes, unless otherwise indicated, fibers, yarns, fabrics and/or garments or articles comprising same.

As used herein, the articles a and an when used in a claim, are understood to mean one or more of what is claimed or described.

Unless otherwise noted, all component or composition levels are in reference to the active level of that component or composition, and are exclusive of impurities, for example, residual solvents or by-products, which may be present in commercially available sources.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All documents cited are, in relevant part, incorporated herein by reference; the citation of any document is not to be construed as an admission that it is prior art with respect to the present invention.

### Benefit Compositions

Applicants' benefit compositions may take any form, for example, a general treatment composition, a detergent, a wash additive or a rinse additive. When such benefit composition takes the form of a general treatment composition, such composition may comprise from about 0.1% to about 60%, from about 0.5% to about 50%, or even from about 1% to about 40% of a chelating agent, from about 0.1% to about 50%, from about 0.5% to about 40%, or even from about 1% to about 30% of a stripping agent and a from about 0.01% to about 40%, from about 0.1% to about 35%, or even from about 0.5% to about 30% of a suspending agent and optionally a pH buffer and optionally one or more cleaning adjuncts.

When such benefit composition is a detergent composition, such composition may comprise from about 0.001% to about 30%, from about 0.05% to about 25%, or even from about 0.01% to about 20% of a chelating agent, from about 0.001% to about 25%, from about 0.05% to about 20%, or even from about 0.01% to about 15% of a stripping agent and a from about 0.01% to about 40%, from about 0.1% to about 35%, or even from about 0.5% to about 30% of a suspending agent and at least one detergent adjunct.

When such benefit composition is in the form of a wash additive or rinse additive, such composition may comprise from about 0.1% to about 60%, from about 0.5% to about 50%, or even from about 1% to about 40% of a chelating agent, from about 0.1% to about 50%, from about 0.5% to about 40%, or even from about 1% to about 30% of a stripping agent and a from about 0.01% to about 40%, from about 0.1% to about 35%, or even from about 0.5% to about 30% of a suspending agent and a sufficient amount of pH buffer to provide a neat product pH of from about 1 to about 9, from about 1.5 to about 8, or even form about 2 to about 7.

Any balance of any of the aforementioned compositions may be a carrier.

In one aspect of the invention, the pH buffer comprises citric acid.

In one aspect of Applicants' invention, such benefit compositions are capable of maintaining or rejuvenating a textile product's stain repellency when said textile product is contacted with such textile benefit composition.

In one aspect of Applicants' invention, such textile benefit compositions do not contain one or more adjuncts materials, for example, bleach activators, surfactants, builders, dye transfer inhibiting agents, dispersants, enzymes, and enzyme stabilizers, catalytic metal complexes, polymeric dispersing agents, clay and soil removal/anti-redeposition agents, brighteners, suds suppressors, dyes, perfumes, structure elasticizing agents, fabric softeners, carriers, hydrotropes, processing aids and/or pigments.

Useful chelating agents include chelating agents selected from the group consisting of aminocarboxylates, phosphonates, polyfunctionally-substituted aromatic chelating agents, and mixtures thereof. Useful aminocarboxylates include ethylenediaminetetracetates, N-hydroxyethylethylenediaminetriacetates, nitrilotriacetates, ethylenediamine tetraproprionates, triethylenetetraaminehexacetates, diethylenetriaminepentaacetates, and ethanoldiglycines, alkali metal, ammonium and substituted ammonium salts of such aminocarboxylates. Useful phosphonates include aminophosphonates. Useful polyfunctionally-substituted aromatic chelating agents include 1-hydroxy-2,4-disulfo-6-carboxybenzene, 1,3,5-trihydroxy-2-carboxybenzene, 1,3,5-tris[carboxyethylether]-2-carboxybenzene, 2,4-disulfo-1,5-dihydrobenzene, 1,4-bis[carboxymethylether]-2,5-dicarboxybenzene and mixtures thereof. Additional examples of polyfunctionally-substituted aromatic chelating agents can be found in U.S. Pat. No. 3,812,044.

Useful stripping agents include cationic materials selected from the group consisting of protonatable amines, alkyl quatemary ammonium compounds, cationic silicones, cationic polymers and mixtures thereof. Suitable protonatable amines include, protonatable amines having Formula I below:

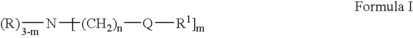

wherein the index m=0, 1, 2 or 3; the index n=1, 2, 3 or 4, preferably n is 2 or 3, more preferably n is 2, each R is independently selected from C₁-C₂₂ alkyl, C₁-C₂₂ hydroxyalkyl or a benzyl group; each R¹ is independently selected from C₁₁-C₂₂ linear alkyl, C₁₁-C₂₂ branched alkyl, C₁₁-C₂₂ linear alkenyl, or C₁₁-C₂₂ branched alkenyl; and each Q may comprise a carbonyl, carboxyl, or amide moiety.

Suitable alkylated quaternary ammonium compounds (quats), include mono-alkyl quats, di-alkyl, tri-alkyl quats and tetra-alkyl quats and certain cationic surfactants. Suitable mono-alkyl quats, di-alkyl, tri-alkyl quats and tetra-alkyl quats typically have Formula II below:

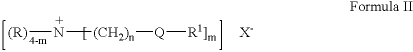

wherein the index m=0, 1, 2, 3 or 4; the index n=1, 2, 3 or 4, preferably n is 2 or 3, more preferably n is 2, each R is independently selected from C₁-C₂₂ alkyl, C₁-C₂₂ hydroxyalkyl, or a benzyl group; each R¹ is independently selected from C₁₁-C₂₂ linear alkyl, C₁₁-C₂₂ branched alkyl, C₁₁-C₂₂ linear alkenyl, or C₁₁-C₂₂ branched alkenyl; X⁻ is a water soluble anionic species such as chloride, bromide or methyl sulfate, and Q may comprise a carbonyl, carboxyl, or amide moiety.

Suitable cationic silicones include silicones functionalized by amine derived compounds and cationic silicone polymers. Suitable silicones functionalized by amine derived compounds include amino silicones having Formula III below:

(R¹R²R³SiO_{1/2})ₚ(R⁴R⁴SiO_{2/2})ₘ[R⁴Si(L-NR⁵R⁶)O_{2/2}]ₐ[Si(K—NR⁷R⁸O_{3/2}]_{b}[R⁴SiO_{3/2}]_{c} Formula III

wherein m, a, b, and c can be independently selected from integers between 0 and 6000; p=2+b+c; R¹, R², R³, R^{4,} R⁵, R⁶, R⁷ R⁸, L, K may be various side chains attached to the silicone or nitrogen atoms within the molecule. In Formula IV above, R¹, R², R³, R⁴ can be independently selected from:
1.) C₁-C₂₂ linear or branched, substituted or unsubstituted hydrocarbyl moiety; or
2.) —O—R¹¹, —O—R¹², —O—R¹³, and —O—R¹⁴, wherein R¹¹, R¹², R¹³, and R¹⁴ can be independently selected from H, or C₁-C₂₂ linear or branched, substituted or unsubstituted hydrocarbyl moiety.
   In Formula III above, L and K can be independently selected from C₁-C₂₂ linear or branched, substituted or unsubstituted hydrocarbyl moieties. In one aspect L and K can be independently selected from C₁-C₁₂ linear or branched, substituted or unsubstituted hydrocarbyl moieties. In another aspect, L and K can be independently selected from C₁-C₄ linear or branched, substituted or unsubstituted hydrocarbyl moieties. In another aspect L and K can be independently selected from methylene, ethylene, propylene, 2-methylpropylene, butylene, octadecylene or 3-(2,2′,6,6′-tetramethyl-4-oxy-piperidyl)propyl. In Formula III above, R⁵, R⁶, R⁷ and R⁸ can be independently selected from H, or C₁-C₂₂ linear or branched, substituted or unsubstituted hydrocarbyl moieties.

### As used in Formula III above, “SiO_{n/2}” means the ratio of oxygen atoms to silicon atoms, i.e., SiO_{1/2} means one oxygen atom is shared between two silicon atoms.

Suitable cationic silicone polymers include cationic silicone polymers having Formula IV below:

[CAP]-Zₘ-[CAP] Formula IV

wherein [CAP] can be a backbone termination or truncation unit; m can be an integer from 1 to 50 and each Z unit may have Formula V below:

—(R)ₓ—W—(R)ₓ— Formula V
wherein for Formula V:
   x can be 0 or 1;
   W can be a siloxane unit having Formula VI below:

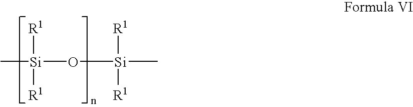

wherein for Formula VI each R¹ unit can be a C₁-C₂₂ linear or branched, substituted or unsubstituted hydrocarbyl moiety;
wherein for Formula V above R can have Formula VII below:

-[(L)_{y}-(R²)_{y}-(L)_{y}]-B-[(L)_{y}-(R²)_{y}-(L)_{y}]- Formula VII
wherein for Formula VII above:
   y can be 0 or 1;
   L can be a suitable carbon containing linking unit, suitable linking units include, but are not limited to, alkylene moieties, acrylate moieties, and amide containing moieties;
   each B can be a unit comprising at least one secondary, tertiary, or quaternary amino moiety;
   R² can be a coupling unit having the Formula VIII below:

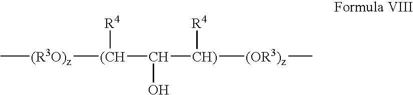

wherein for Formula VIII:
each R³ can be independently selected from a C₂-C₁₂ linear or branched alkylene moiety, in one aspect each R³ can be independently ethylene, 1,3-propylene, or 1,2-propylene;
each R⁴ can be independently selected from hydrogen, or a C₁-C₂₂ linear or branched, substituted or unsubstituted hydrocarbyl moiety, in one aspect each R⁴ can be independently selected from hydrogen, a C₁-C₂₂ linear or branched alkyl moiety; a C₁-C₂₂ cycloalkyl moiety; a C₁-C₂₂ linear or branched fluoroalkyl moiety; a C₂-C₂₂ linear or branched alkenyl moiety; a C₆-C₂₂ aryl moiety; or a C₇-C₂₂ alkylenearyl moiety; in another aspect each R⁴ can be hydrogen, or a C₁-C₁₀ linear or branched alkyl moiety; and
z can be an integer from 0 to 50;

Suitable cationic surfactants include quaternary ammonium surfactants selected from the group consisting of mono C₆-C₁₆, C₆-C₁₀ N-alkyl or alkenyl ammonium surfactants, wherein the remaining N positions are substituted by methyl, hydroxyehthyl or hydroxypropyl groups. In one aspect the cationic surfactant may be C₆-C₁₈ alkyl or an alkenyl ester of an quaternary ammonium alcohol, such as quaternary choline esters. In one aspect cationic surfactants have Formula IX below:

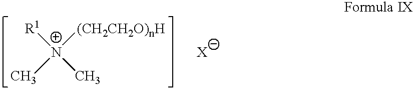

wherein R¹ is a C₈-C₁₈ hydrocarbyl, C₈₋₁₄ alkyl, or even C₈, C₁₀ or C₁₂ alkyl, and X⁻ is a water soluble anionic species such as chloride, bromide or methyl sulfate.

Useful suspending agents include anionic polymers, modified polyamine polymers and mixtures thereof. Suitable anionic polymers include random polymers, block polymers and mixtures thereof. Such polymers typically comprise first and second moieties in a ratio of from about 100:1 to about 1:5. Suitable first moieties include moieties derived from monoethylenically unsaturated C₃-C₈ monomers comprising at least one carboxylic acid group, salts of such monomers, and mixtures thereof. Non-limiting examples of suitable monomers include monoethylenically unsaturated C₃-C₈ monocarboxylic acids and C₄-C₈ dicarboxylic acids selected from the group consisting of acrylic acid, methacrylic acid, beta-acryloxypropionic acid, vinyl acetic acid, vinyl propionic acid, crotonic acid, ethacrylic acid, alpha-chloro acrylic acid, alpha-cyano acrylic acid, maleic acid, maleic anhydride, fumaric acid, itaconic acid, citraconic acid, mesaconic acid, methylenemalonic acid, their salts, and mixtures thereof. In one aspect of Applicants' invention, suitable first moieties comprise monomers that are entirely selected from the group consisting of: acrylic acid, methacrylic acid, maleic acid and mixtures thereof.

Suitable second moieties include:

1.) Moieties derived from modified unsaturated monomers having the formulae R—Y-L and R-Z wherein:
a.) R can be selected from the group consisting of C(X)H═C(R¹)— where
   (i) R¹ can be H, or C₁-C₄ alkyl; and
   (ii) X can be H, CO₂H, or CO₂R₂ wherein R₂ can be hydrogen, alkali metals, alkaline earth metals, ammonium and amine bases, saturated C₁-C₂₀ alkyl, C₆-C₁₂ aryl, and C₇-C₂₀ alkylaryl;
b.) Y can be selected from the group consisting of —CH₂—, —CO₂—, —OCO—, and —CON(R^{a})—, —CH₂OCO—; wherein R^{a} can be H or C₁-C₄ alkyl;
c.) L can be selected from the group consisting of hydrogen, alkali metals, alkaline earth metals, ammonium and amine bases, saturated C₁-C₂₀ alkyl, C₆-C₁₂ aryl, and C₇-C₂₀ alkylaryl; and
d.) Z can be selected from the group consisting of C₆-C₁₂ aryl and C₇-C₁₂ arylalkyl.

In another aspect of Applicants' invention:
a.) R can be selected from the group consisting of C(X)H═C(R¹)— where
   (i) R² can be H and
   (ii) X can be H, or CO₂H;
b.) Y can be —CO₂—;
c.) L can be selected from the group consisting of hydrogen, alkali metals, C₆-C₁₂ aryl, and C₇-C₂₀ alkylaryl; and
d.) Z can be selected from the group consisting of C₆-C₁₂ aryl and C₇-C₁₂ arylalkyl.

In still another aspect of Applicants' invention the variables R, R¹, Y, L and Z can be as described immediately above and the variable X can be H.

Suitable anionic polymers comprising such first and second moieties typically have weight-average molecular weights of from about 1000 Da to about 100,000 Da.

Another class of suitable second moiety includes moieties derived from ethylenically unsaturated monomers containing from 1 to 100 repeat units selected from the group consisting of C₁-C₄ carbon alkoxides and mixtures thereof. An example of such an unsaturated monomer is represented by the formula J-G-D wherein:

1.) J can be selected from the group consisting of C(X)H═C(R₁)— wherein
a.) R₁ can be H, or C₁-C₄ alkyl;
b.) X can be H, CO₂H, or CO₂R₂ wherein R₂ can be hydrogen, alkali metals, alkaline earth metals, ammonium and amine bases, saturated C₂-C₂₀ alkyl, C₆-C₁₂ aryl, C₇-C₂₀ alkylaryl;

2.) G can be selected from the group consisting of C₁-C₄ alkyl, —O—, —CH₂O—, —CO₂—.

3.) D can be selected from the group consisting of
a.) —CH₂CH(OH)CH₂O(R³O)_{d}R₄;
b.) —CH₂CH[O(R³O)_{d}R⁴]CH₂OH;
c.) —CH₂CH(OH)CH₂NR⁵(R³O)_{d}R⁴;
d.) —CH₂CH[NR⁵(R³O)_{d}R⁴]CH₂OH, and mixtures thereof; wherein

R³ can be selected from the group consisting of ethylene, 1,2-propylene, 1,3-propylene, 1,2-butylene, 1,4-butylene, and mixtures thereof;

R⁴ can be a capping unit selected from the group consisting of H, C₁-C₄ alkyl, C₆-C₁₂ aryl and C₇-C₂₀ alkylaryl;

R⁵ can be selected from the group consisting of H, C₁-C₄ alkyl C₆-C₁₂ aryl and C₇-C₂₀ alkylaryl; and

subscript index d can be an integer from 1 to 100.

In another aspect of Applicants' invention:

1.) J can be selected from the group consisting of C(X)H═C(R₁)— wherein
a.) R₁ can be H, or C₁-C₄ alkyl;
b.) X can be H or CO₂H;

2.) G can be selected from the group consisting of —O—, —CH₂O—, —CO₂—.

3.) D can be selected from the group consisting of
a.) —CH₂CH(OH)CH₂O(R³O)_{d}R₄;
b.) —CH₂CH[O(R³O)_{d}R⁴]CH₂OH, and mixtures thereof; wherein

R³ can be ethylene;

R⁴ can be a capping unit selected from the group consisting of H, and C₁-C₄ alkyl; and

d can be an integer from 1 to 100.

In still another aspect of Applicants' invention the variables J, D, R³ and d can be as described immediately above and the variables R₁ and X can be H, G can be —CO₂—.and R⁴ can be C₁-C₄ alkyl.

Suitable anionic polymers comprising such first and second moieties typically have weight-average molecular weights of from about 2000 Da to about 100,000 Da.

Other suitable anionic polymers include graft co-polymers that comprise the first moieties previously described herein, and typically have weight-average molecular weights of from about 1000 Da to about 50,000 Da. In such polymers, the aforementioned first moieties are typically grafted onto a C₁-C₄ carbon polyalkylene oxide.

Suitable modified polyamine polymers include modified polyamines having the formulae:

V₍ₙ₊₁₎WₘYₙZ

or

V₍ₙ₋ₖ₊₁₎WₘYₙY′ₖZ

wherein m can be an integer from 0 to about 400; n can be an integer from 0 to about 400; k can be less than or equal to n wherein

i) V units can be terminal units having the formula:

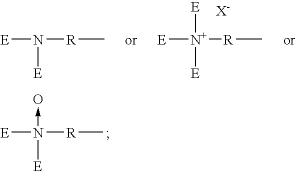

ii) W units can be backbone units having the formula:

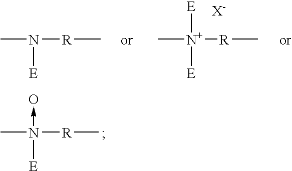

iii) Y and Y′ units can be branching units having the formula:

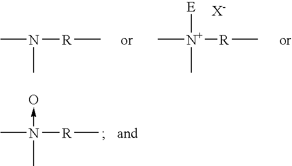

iv) Z units can be terminal units having the formula:

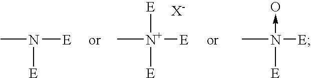

wherein:
R units can be selected from the group consisting of C₂-C₁₂ alkylene, C₄-C₁₂ alkenylene, C₃-C₁₂ hydroxyalkylene, C₄-C₁₂ dihydroxy-alkylene, C₈-C₁₂ dialkylarylene, —(R¹O)ₓR¹—, —(R¹O)ₓR⁵(OR¹)ₓ—, —(CH₂CH(OR²)CH₂O)_{z}—(R¹O)_{y}R¹(OCH₂CH(OR²)CH₂)_{w}—, —C(O)(R⁴)ᵣC(O)—, —CH₂CH(OR²)CH₂—, and mixtures thereof; wherein
   R¹ can be C₂-C₃ alkylene and mixtures thereof;
   R² can be hydrogen, —(R¹O)ₓB, and mixtures thereof;
      wherein at least one B can be selected from the group consisting of —(CH₂)_{q}—SO₃M, —(CH₂)ₚCO₂M, —(CH₂)_{q}(CHSO₃M)CH₂SO₃M, —(CH₂)_{q}—(CHSO₂M)CH₂SO₃M, —(CH₂)ₚPO₃M, —PO₃M, and mixtures thereof, and any remaining B moieties can be selected from the group consisting of hydrogen, C₁-C₆ alkyl, —(CH₂)_{q}—SO₃M, —(CH₂)ₚCO₂M, —(CH₂)_{q}(CHSO₃M)CH₂SO₃M, (CH₂)_{q}—(CHSO₂M)CH₂SO₃M, —(CH₂)ₚPO₃M, —PO₃M, and mixtures thereof;
   R⁴ can be C₁-C₁₂ alkylene, C₄-C₁₂ alkenylene, C₈-C₁₂ arylalkylene, C₆-C₁₀ arylene, and mixtures thereof;
   R⁵ can be C₁-C₁₂ alkylene, C₃-C₁₂ hydroxy-alkylene, C₄-C₁₂ dihydroxyalkylene, C₈-C₁₂ dialkylarylene, —C(O)—, —C(O)NHR⁶NHC(O)—, —R¹(OR¹)—, —C(O)(R⁴)ᵣC(O)—, —CH₂CH(OH)CH₂—, —CH₂CH(OH)CH₂O(R¹O)_{y}R¹—OCH₂CH(OH)CH₂—, and mixtures thereof;
   R⁶ is C₂-C₁₂ alkylene or C₆-C₁₂ arylene;
   X can be a water soluble anion; provided at least one backbone nitrogen is quaternized or oxidized
   E units can be selected from the group consisting of hydrogen, C₁-C₂₂ alkyl, C₃-C₂₂ alkenyl, C₇-C₂₂ arylalkyl, C₂-C₂₂ hydroxyalkyl, —(CH₂)ₚCO₂M, —(CH₂)_{q}SO₃M, —CH(CH₂CO₂M)—CO₂M, —(CH₂)ₚPO₃M, —(R¹O)ₓB, —C(O)R³, and mixtures thereof;
   provided that when any E unit of a nitrogen is a hydrogen, said nitrogen is not also an N-oxide;
      R¹ can be C₂-C₃ alkylene and mixtures thereof;
      R³ can be C₁-C₁₈ alkyl, C₇-C₁₂ arylalkyl, C₇-C₁₂ alkyl substituted aryl, C₆-C₁₂ aryl, and mixtures thereof;
      at least one B can be selected from the group consisting of —(CH₂)_{q}—SO₃M, —(CH₂)ₚCO₂M, —(CH₂)_{q}(CHSO₃M)CH₂SO₃M, —(CH₂)_{q}—(CHSO₂M)CH₂SO₃M, —(CH₂)ₚPO₃M, —PO₃M, and mixtures thereof, and any remaining B moieties can be selected from the group consisting of hydrogen, C₁-C₆ alkyl, —(CH₂)_{q}—SO₃M, —(CH₂)ₚCO₂M, —(CH₂)_{q}(CHSO₃M)CH₂SO₃M, —(CH₂)_{q}—(CHSO₂M)CH₂SO₃M, —(CH₂)ₚPO₃M, —PO₃M, and mixtures thereof;
      M can be hydrogen or a water soluble cation in sufficient amount to satisfy charge balance; and
   wherein the values for the following indices are as follows: subscript index p can be an integer from 1 to 6; subscript index q can be an integer from 0 to 6; subscript index r can have the value of 0 or 1; subscript index w can have the value 0 or 1; subscript index x can be an integer from 1 to 100; subscript index y can be an integer from 0 to 100; and subscript index z can have the value 0 or 1.

In another embodiment of Applicants' invention the aforementioned variables can be as follows:
R units can be selected from the group consisting of C₂-C₁₂ alkylene, —(R¹O)ₓR¹—, and mixtures thereof; wherein R¹ can be C₂-C₃ alkylene and mixtures thereof;
X can be a water soluble anion; provided at least one backbone nitrogen is quaternized or oxidized
E units can be —(R¹O)ₓB wherein
   R¹ can be C₂-C₃ alkylene and mixtures thereof; and
   B can be hydrogen, —(CH₂)_{q}—SO₃M, —(CH₂)ₚCO₂M, and mixtures thereof;
   M can be hydrogen or a water soluble cation in sufficient amount to satisfy charge balance; and
subscript p can be an integer from 1 to 6; subscript q can be 0; subscript r can have the value of 0 or 1; subscript w can have the value 0 or 1; subscript x can be an integer from 1 to 100; subscript y can be an integer from 0 to 100; and subscript z can have the value 0 or 1.

In still another aspect of Applicants' invention all variables can be as described immediately above except B can be hydrogen, —(CH₂)_{q}—SO₃M, and mixtures thereof.

Additional suitable modified polyamines include modified polyamines having Formula (X):

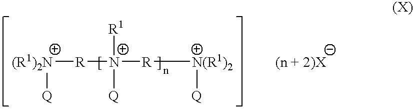

wherein R can be C₆-C₂₀ linear or branched alkylene, and mixtures thereof; X in Formula (X) can be an anion present in sufficient amount to provide electronic neutrality; n and subscript index n in Formula (X) can have equal values and can be integers from 0 to 4; R¹ in Formula (X) can be a capped polyalkyleneoxy unit having Formula (IX):

—(R²O)ₓ—R³ (IX)

wherein R² in Formula (IX) can be C₂-C₄ linear or branched alkylene, and mixtures thereof; subscript index x in Formula (IX) describes the average number of alkyleneoxy units attached to the backbone nitrogen, such index can have a value from about 1 to about 50, in another aspect of Applicants' invention such index can have a value from about 15 to about 25; at least one R³ moiety in Formula (IX) can be an anionic capping unit, with the remaining R³ moieties in Formula (IX) selected from the group comprising hydrogen, C₁-C₂₂ alkylenearyl, an anionic capping unit, a neutral capping unit, and mixtures thereof; at least one Q moiety, in Formula (X) can be a hydrophobic quaternizing unit selected from the group comprising C₇-C₃₀ substituted or unsubstituted alkylenearyl, and mixtures thereof, any remaining Q moieties in Formula (X) can be selected from the group comprising lone pairs of electrons on the unreacted nitrogens, hydrogen, C₁-C₃₀ substituted or unsubstituted linear or branched alkyl, or C₃-C₃₀ substituted or unsubstituted cycloalkyl, and mixtures thereof.

In still another aspect of Applicants' invention all variables for Formula X and XI are the same except R in Formula X can be C₆-C₂₀ linear alkylene, and mixtures thereof; and R² in Formula (IX) can be C₂-C₄ linear alkylene, and mixtures thereof;

Examples of suitable modified polyamines include modified polyamines having the following structures. As with all polymers containing alkyleneoxy units it is understood that only an average number or statistical distribution of alkyleneoxy units will be known. Therefore, depending upon how “tightly” or how “exactly” a polyamine is alkoxylated, the average value may vary from embodiment to embodiment.

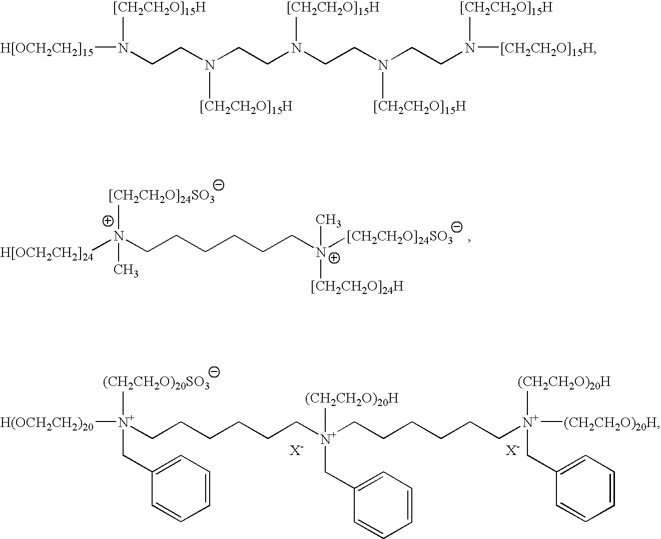

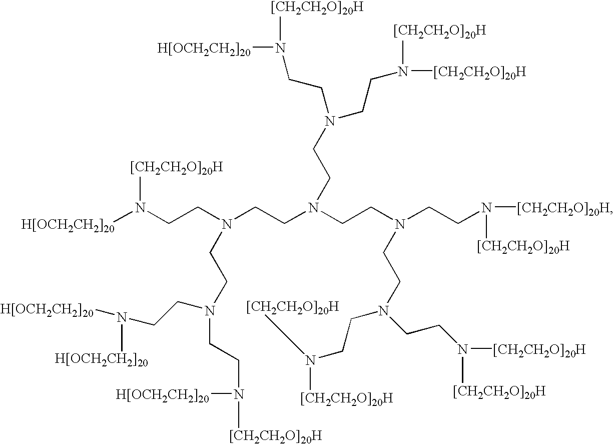

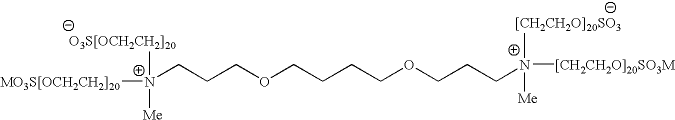

Suitable modified polyamines, as disclosed herein, may be produced in accordance with the processes and methods disclosed in Applicants examples.

Useful pH buffers include a material selected from the group consisting of organic acids, inorganic acids and mixtures there of. Useful organic acids include organic acids selected from the group consisting of an organic carboxylic acid, a polycarboxylic acid and mixtures thereof. Typically, the organic acids preferably have equivalent weights that are less than or equal to about 80 Daltons. Examples of suitable organic acids include: adipic, aspartic, carboxymethyloxymalonic, carboxymethyloxysuccinic, citric, glutaric, hydroxyethyliminodiacetic, iminodiacetic, maleic, malic, malonic, oxydiacetic, oxydisuccinic, succinic, sulfamic, tartaric, tartaric-disuccinic, tartaric-monosuccinic and mixtures thereof. Useful inorganic acids include inorganic acids selected from the group consisting of hydrochloric acid, sulfuric acid, phosphoric acid and mixtures hereof. Typically the inorganic is used in conjunction with an organic acid.

Useful carriers may comprise water. For, example, a useful carrier is water. The aforementioned useful materials may be obtained as follows: useful chelating agents Aldrich, P.O. Box 2060, Milwaukee, Wis. 53201, USA; useful stripping agents may be obtained from Akzo Nobel, Velperweg 76, 6824 BM Arnhem P.O. Box 9300, 6800 SB Arnhem; useful suspending agents include, Alcosperse® 725 and Alcosperse® 747 available from Alco Chemical of Chattanooga, Tenn. U.S.A. and Acusol® 480N from Rohm & Haas Co. of Spring House, Pa. U.S.A., IMS and PLS polymers supplied by Nippon Shokubai Co., Ltd of Osaka, Japan and Sokalan® ES 8305, Sokalan® HP 25, and Densotan® A supplied by BASF Corporation of New Jersey, U.S.A.; and useful pH buffers may be obtained from Aldrich, P.O. Box 2060, Milwaukee, Wis. 53201, USA.

### Adjunct Materials

While certain embodiments of Applicants textile benefit compositions do not contain one or more of the adjunct materials listed herein as such adjuncts are not essential for the purposes of the present invention, other embodiments may contain one or more adjuncts illustrated hereinafter. Such adjuncts may be incorporated in the textile benefit compositions disclosed herein, for example to assist or enhance cleaning performance, or to modify the aesthetics of such compositions as is the case with perfumes, colorants, dyes or the like. The precise nature of these additional components, and levels of incorporation thereof, will depend on the physical form of the textile benefit composition and the nature of the operation for which it is to be used and applied. Useful adjunct materials may include, but are not limited to, bleach activators, surfactants, builders, dye transfer inhibiting agents, dispersants, enzymes, and enzyme stabilizers, catalytic metal complexes, polymeric dispersing agents, clay and soil removal/anti-redeposition agents, brighteners, suds suppressors, dyes, perfumes, structure elasticizing agents, fabric softeners, carriers, hydrotropes, processing aids and/or pigments.

### Processes of Making Textile Benefit Compositions

The skilled artisan can produce the textile benefit compositions of the present invention by following the teaching contained herein and in the examples as such compositions may be made by combining the requisite materials.

Commercial quantities of such textile benefit compositions can be made using a variety of reaction vessels and processes including batch, semi-batch and continuous processes. Such equipment may be obtained from a variety of sources such as Lodige GmbH (Paderborn, Germany), Littleford Day, Inc. (Florence, Ky., U.S.A.), Forberg AS (Larvik, Norway), Glatt Ingenieurtechnik GmbH (Weimar, Germany), Niro (Soeborg, Denmark), Hosokawa Bepex (Minneapolis, Minn., USA).

### Method of Use

An article may be treated with any of Applicants' benefit compositions or mixtures thereof:

Typically, an article comprising a stain repellant treatment is contacted with the benefit composition in neat form or during a cleaning or washing process. Contact methods include padding wiping, spraying and washing.

Useful equipment for practicing the method disclosed herein includes sponges, cloths, spray bottles and washing units and containers such as washing machines. Treatment methods may comprise contacting the article before during or after a washing step that may optionally include rinsing and/or a drying step.

### Treated Articles

Textile products having enhanced and/or durable stain repellency properties may be made by treating said textile products with Applicants' benefit compositions. Treatment methods include the methods disclosed in the present specification.

### EXAMPLES

### Example 1

### Special Detergent

| Ingredient | wt % |
|---|---|
| AES | 9.77 |
| DTPA¹ | 1.20 |
| citric acid | 5.70 |
| Ethoxylated Polyamine (Suspension | 3.2 |
| agent) | |
| ethanolamine | 1.39 |
| Propanediol | 2.41 |
| Other laundry adjuncts (perfume, enzyme, | Balance |
| dye, brightener, polymers, water, etc.) | |

¹diethylenetriaminepentaacetic acid, sodium salt

### Example 2

### Wash Additive

| Ingredient | wt % |
|---|---|
| DTPA¹ | 18.50 |
| citric acid | 14.82 |
| Ethoxylated Polyamine (Suspension | 3.2 |
| agent) | |
| Barol 561² | 1.5 |
| Other laundry adjuncts (surfactant, | Balance |
| perfume, enzyme, dye, brightener, | |
| polymers, water, etc.) | |

¹diethylenetriaminepentaacetic acid, sodium salt
²Marketed by Akzonobel

### Example 3

### Rinse Additive

| Ingredient | wt % |
|---|---|
| DTPA¹ | 16.10 |
| citric acid | 12.90 |
| Ethoxylated Polyamine (Suspension | 8.05 |
| agent) | |
| Barol 561² | 12.90 |
| Other laundry adjuncts (surfactant, | Balance |
| perfume, enzyme, dye, brightener, | |
| polymers, water, etc.) | |

¹diethylenetriaminepentaacetic acid, sodium salt
²Marketed by Akzonobel

### For each of Examples I-III the requisite components are pre-dissolved and then combined in a standard batch mixing vessel.

### Fabric Treatment

The compositions of Examples 1-3 are used to treat a situs in the following manner in accordance with the methods described in the present specification.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A composition comprising:
a) from about 0.001% to about 60% of chelating agent;
b) from about 0.001% to about 50% of a stripping agent;
c) from about 0.01% to about 40% of a suspending agent; and
d) an optional pH buffer
the balance of said composition being a carrier and/or an adjunct ingredient.

2. A composition according to claim 1 wherein said pH buffer is present in a sufficient amount to provide a neat product pH of from about 1 to about 9.

3. A compound according to claim 1 wherein said chelating agent is selected from the group consisting of aminocarboxylates, phosphonates, polyfunctionally-substituted aromatic chelating agents, and mixtures thereof.

4. A composition according to claim 1 wherein said stripping agent is selected from the group consisting of protonatable amines, alkyl quaternary ammonium compounds, cationic silicones, cationic polymers and mixtures thereof.

5. A compound according to claim 1 wherein said suspending agent is selected from the group consisting of anionic polymers, modified polyamine polymers and mixtures thereof.

6. A composition according to claim 1 wherein said optional pH buffer is selected from the group consisting of organic acids, inorganic acids and mixtures thereof.

7. A composition according to claim 1 wherein;
a.) said chelating agent is selected from the group consisting of aminocarboxylates, phosphonates, polyfunctionally-substituted aromatic chelating agents, and mixtures thereof
b.) said stripping agent is selected from the group consisting of protonatable amines, alkyl quaternary ammonium compounds, cationic silicones, cationic polymers and mixtures thereof;
c.) said suspending agent is selected from the group consisting of anionic polymers, modified polyamine polymers and mixtures thereof; and
d.) said optional pH buffer is selected from the group consisting of organic acids, inorganic acids and mixtures thereof.

8. A composition according to claim 1 comprising
a.) from about 0.1% to about 60% of chelating agent;
b.) from about 1% to about 40% of a stripping agent;
c.) from about 0.01% to about 40% of a suspending agent; and
d.) an optional pH buffer;
the balance of said composition being a carrier and/or an adjunct ingredient.

9. A composition according to claim 8 comprising:
a.) from about 0.5% to about 50% of chelating agent;
b.) from about 0.5% to about 40% of a stripping agent;
c.) from about 0.1% to about 35% of a suspending agent; and
d.) an optional pH buffer;
the balance of said composition being a carrier and/or an adjunct ingredient.

10. A compound according to claim 1 comprising.
a.) from about 1% to about 40% of chelating agent;
b.) from about 1% to about 30% of a stripping agent;
c.) from about 0.5% to about 30% of a suspending agent; and
d.) an optional pH buffer;
the balance of said composition being a carrier and/or an adjunct ingredient.

11. A composition according to claim 9 wherein said pH buffer is present in a sufficient amount to provide a neat product pH of from about 1.5 to about 8.

12. A compound according to claim 9 wherein said pH buffer is present in a sufficient amount to provide a neat product pH of from about 2 to about 7.

13. A composition according to claim 1.
a.) from about 0.001% to about 30% of chelating agent;
b.) from about 0.001% to about 25% of a stripping agent;
c.) from about 0.01% to about 40% of a suspending agent; and
d.) an optional pH buffer;
the balance of said composition comprising at least one detergent adjunct.

14. A composition according to claim 1.
a.) from about 0.5% to about 25% of chelating agent;
b.) from about 0.05% to about 20% of a stripping agent;
c.) from about 0.1% to about 35% of a suspending agent; and
d.) an optional pH buffer;
the balance of said composition being a carrier and/or an adjunct ingredient.

15. A composition according to claim 1.
a.) from about 0.01% to about 20% of chelating agent;
b.) from about 0.01% to about 15% of a stripping agent;
c.) from about 0.5% to about 30% of a suspending agent; and
d.) an optional pH buffer;
the balance of said composition being a carrier and/or an adjunct ingredient.

16. A method of treating a surface or article comprising the step of:
a.) optionally washing and/or rinsing said surface or article;
b.) contacting at least a portion of a textile product with the composition of claim 1; and
c.) optionally washing and/or rinsing said surface or article.

17. The method of claim 16 wherein said surface or article is a textile product.

18. The method of claim 16 wherein said contacting step comprises an operation selected from saturating, spraying, padding, exhaustion and combinations thereof.

19. A treated article or surface made by the method of claim 16.

20. A composition according to claim 12 wherein:
a.) said chelating agent is selected from the group consisting of aminocarboxylates, phosphonates, polyfunctionally-substituted aromatic chelating agents, and mixtures thereof
b.) said stripping agent is selected from the group consisting of protonatable amines, alkyl quaternary ammonium compounds, cationic silicones, cationic polymers and mixtures thereof;
c.) said suspending agent is selected from the group consisting of anionic polymers, modified polyamine polymers and mixtures thereof; and
d.) said pH buffer is selected from the group consisting of organic acids, inorganic acids and mixtures thereof.
